(19) United States
(12) Patent Application Publication
(10) Pub. No.: US 2020/0192354 A1
(43) Pub. Date: Jun. 18, 2020

(54) REMOTE DRIVING METHOD, APPARATUS, DEVICE AND COMPUTER READABLE STORAGE MEDIUM

(71) Applicant: BEIJING BAIDU NETCOM SCIENCE TECHNOLOGY CO., LTD., BEIJING (CN)

(72) Inventor: SHI HU, BEIJING (CN)

(21) Appl. No.: 16/716,311

(22) Filed: Dec. 16, 2019

(30) Foreign Application Priority Data
Dec. 17, 2018 (CN) 201811543811.0

(51) Int. Cl. G05D 1/00

(52) U.S. Cl. CPC G05D 1/0044; G05D 1/0061

(57) ABSTRACT

The present disclosure provides remote driving method, apparatus, device, and a computer readable storage medium, where the method includes: receiving a driving instruction sent by a simulated cockpit, where the driving instruction is collected by a motion collector in the simulated cockpit according to a motion of a user; and sending the driving instruction to an unmanned vehicle corresponding to the simulated cockpit, so as to enable the unmanned vehicle to travel according to the driving instruction. By setting up the simulated cockpit, it is possible to realize remote driving of the unmanned vehicle and to improve a driving safety of the unmanned vehicle.

### CROSS-REFERENCE TO RELATED APPLICATION

This application claims priority to Chinese Patent Application No. 201811543811.0, filed on Dec. 17, 2018, which is hereby incorporated by reference in its entirety.

### TECHNICAL FIELD

The present disclosure relates to the field of unmanned vehicles, and more particularly, to remote driving method, apparatus, device and a computer readable storage medium.

### BACKGROUND

An unmanned vehicle is a smart vehicle that perceives a road environment through an onboard sensing system, automatically plans a driving route and controls the vehicle to reach an intended target. It uses an onboard sensor to perceive a surrounding environment of the vehicle, and controls a steering and speed of the vehicle based on the road, vehicle position and obstacle information obtained through perception, thereby enabling the vehicle to travel safely and reliably on the road.

At present, the unmanned vehicle is applied in various fields. In order to ensure a traveling safety of the unmanned vehicle, generally, it is necessary to assign a safety officer on the unmanned vehicle to monitor a current traveling state of the unmanned vehicle and perform a manual intervention in case of an error in the traveling process of the unmanned vehicle. However, an automatic driving control over the unmanned vehicle cannot be realized remotely, and the driving of the unmanned vehicle can only be realized manually by entering the unmanned vehicle, accordingly, the operation is often cumbersome and costs more human resources.

### SUMMARY

The present disclosure provides remote driving method, apparatus, device and a computer readable storage medium, which can solve the technical problem in the prior art that an automatic driving control over the unmanned vehicle cannot be realized remotely, and the driving of the unmanned vehicle can only be realized manually by entering the unmanned vehicle, accordingly, the operation is often cumbersome and costs more human resources.

A first aspect of the present disclosure provides a remote driving method, including:

receiving a driving instruction sent by a simulated cockpit, where the driving instruction is collected by a motion collector in the simulated cockpit according to a motion of a user; and

sending the driving instruction to an unmanned vehicle corresponding to the simulated cockpit, so as to enable the unmanned vehicle to travel according to the driving instruction.

Another aspect of the present disclosure provides a remote driving apparatus, including:

a driving instruction receiving module, configured to receive a driving instruction sent by a simulated cockpit, where the driving instruction is collected by a motion collector in the simulated cockpit according to a motion of a user; and

a driving instruction sending module, configured to send the driving instruction to an unmanned vehicle corresponding to the simulated cockpit, so as to enable the unmanned vehicle to travel according to the driving instruction.

Yet another aspect of the present disclosure provides a remote driving device, including: a memory and a processor;

the memory is configured to store instructions executable by the processor;

where the processor is configured to perform the remote driving method described above.

Yet another aspect of the present disclosure provides a computer readable storage medium, where the computer readable storage medium has stored therein a computer executed instruction that, when executed by a processor, is configured to implement the remote driving method described above.

The remote driving method, apparatus, device and computer readable storage medium provided by the present disclosure receive a driving instruction sent by a simulated cockpit, where the driving instruction is collected by a motion collector in the simulated cockpit according to a motion of a user; and send the driving instruction to an unmanned vehicle corresponding to the simulated cockpit, so as to enable the unmanned vehicle to travel according to the driving instruction. By setting up the simulated cockpit, it is possible to realize remote driving of the unmanned vehicle and to improve a driving safety of the unmanned vehicle.

### BRIEF DESCRIPTION OF THE DRAWINGS

In order to more clearly illustrate the technical solutions in embodiments of the present disclosure or in the prior art, a brief introduction to the drawings used for describing the embodiments or the prior art will be made below. Obviously, the drawings in the following description are some embodiments of the present disclosure, and those skilled in the art may still derive other drawings from these drawings without any creative effort.

FIG. 1 is a schematic diagram of a network architecture on which the present disclosure is based;

FIG. 2 is a schematic flowchart of a remote driving method according to Embodiment I of the present disclosure;

FIG. 3 is a schematic flowchart of a remote driving method according to Embodiment II of the present disclosure;

FIG. 4 is a schematic flowchart of a remote driving method according to Embodiment III of the present disclosure;

FIG. 5 is a schematic structural diagram of a remote driving apparatus according to Embodiment IV of the present disclosure;

FIG. 6 is a schematic structural diagram of a remote driving apparatus according to Embodiment V of the present disclosure; and

FIG. 7 is a schematic structural diagram of a remote driving device according to Embodiment VI of the present disclosure.

### DESCRIPTION OF EMBODIMENTS

To make the purposes, technical solutions and advantages of the embodiments of the present disclosure clearer, the technical solutions in the embodiments of the present disclosure will be clearly and completely described below with reference to the drawings in the embodiments of the present disclosure. Obviously, the described embodiments are some but not all of the embodiments according to the present disclosure. All other embodiments obtained by those skilled in the art based on the embodiments of the present disclosure without creative efforts fall within the protection scope of the present disclosure.

An unmanned vehicle is a smart vehicle that perceives a road environment through an onboard sensing system, automatically plans a driving route and controls the vehicle to reach an intended target. It uses an onboard sensor to perceive a surrounding environment of the vehicle, and controls a steering and speed of the vehicle based on the road, vehicle position and obstacle information obtained through perception, thereby enabling the vehicle to travel safely and reliably on the road. At present, the unmanned vehicle is applied in various fields. In order to ensure a traveling safety of the unmanned vehicle, generally, it is necessary to assign a safety officer on the unmanned vehicle to monitor a current traveling state of the unmanned vehicle and perform a manual intervention in case of an error in the traveling process of the unmanned vehicle. However, an automatic driving control over the unmanned vehicle cannot be realized remotely, and the driving of the unmanned vehicle can only be realized manually by entering the unmanned vehicle, accordingly, the operation is often cumbersome and costs more human resources. In order to solve the above technical problem, the present disclosure provides remote driving method, apparatus, device and a computer readable storage medium.

It should be noted that the remote driving method, apparatus, device and computer readable storage medium provided by the present application can be applied to any scenario for controlling the driving of the unmanned vehicle.

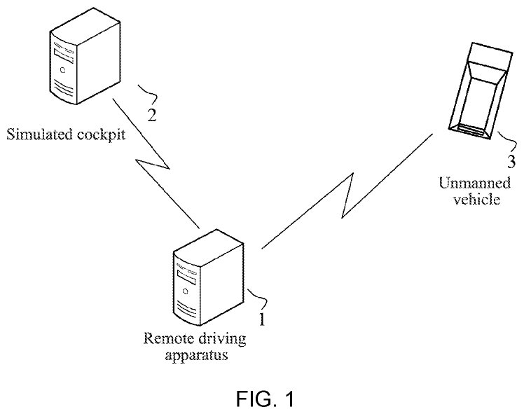

FIG. 1 is a schematic diagram of a network architecture on which the present disclosure is based. As shown in FIG. 1, the network architecture on which the present disclosure is based at least includes: a remote driving apparatus 1, a simulated cockpit 2 and an unmanned vehicle 3. The remote driving apparatus 1 is in communication connection with the simulated cockpit 2 and the unmanned vehicle 3, respectively, thereby enabling information interaction with the simulated cockpit 2 and the unmanned vehicle 3, respectively. The remote driving apparatus 1 can be implemented by software and/or hardware, and when it is implemented by the software, it can be written in a language such as C/C++, Java, Shell or Python.

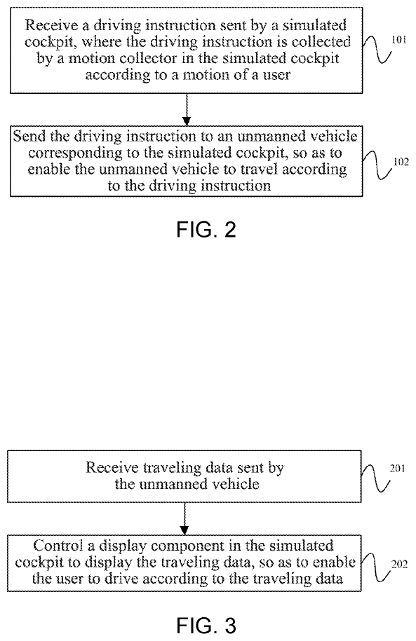

FIG. 2 is a schematic flowchart of a remote driving method according to Embodiment I of the present disclosure. As shown in FIG. 2, the method includes:

Step 101, receiving a driving instruction sent by a simulated cockpit, where the driving instruction is collected by a motion collector in the simulated cockpit according to a motion of a user; and

Step 102, sending the driving instruction to an unmanned vehicle corresponding to the simulated cockpit, so as to enable the unmanned vehicle to travel according to the driving instruction.

An execution body of the present embodiment is a remote driving apparatus. The remote driving apparatus is in communication connection with the unmanned vehicle and the simulated cockpit, respectively, thereby enabling communication interaction with the unmanned vehicle and the simulated cockpit, respectively. In order to realize a remote driving of the unmanned vehicle, the simulated cockpit can be provided. It should be noted that the remote cockpit is provided with components such as a steering wheel and a dashboard, and the specific structure thereof is identical to that of an unmanned vehicle entity, so that the user can enter the simulated cockpit for performing simulated driving operation. In addition, a motion collector is also provided in the simulated cockpit. Specifically, when the user enters the simulated driving, the motion collector can collect the motion of the user in real time, form a driving instruction according to the motion information, and send the driving instruction to the remote driving apparatus, where the motion may specifically be braking, turning the steering wheel, etc. Correspondingly, after receiving the driving instruction, the remote driving apparatus can forward the driving instruction to the unmanned vehicle corresponding to the cockpit, so that the unmanned vehicle can travel safely according to the driving instruction of the user. In an embodiment, there may be multiple simulated cockpits that can correspond to the unmanned vehicles one-to-one, thereby achieving a control over the unmanned vehicles. In addition, the simulated cockpit can also correspond to multiple unmanned vehicles respectively. Before the driving of the unmanned vehicle is required to be controlled, a communication connection can be established with the unmanned vehicle according to a unique vehicle identity of the unmanned vehicle, so as to realize the control over the unmanned vehicle, which is not limited in the present disclosure.

The remote driving method provided by the present embodiment receives the driving instruction sent by the simulated cockpit, where the driving instruction is collected by the motion collector in the simulated cockpit according to the motion of the user, and sends the driving instruction to the unmanned vehicle corresponding to the simulated cockpit, so as to enable the unmanned vehicle to travel according to the driving instruction. By setting up the simulated cockpit, it is possible to realize remote driving of the unmanned vehicle and to improve a driving safety of the unmanned vehicle.

Further, based on any one of the above embodiments, the method includes:

receiving the driving instruction sent by the simulated cockpit through a preset serial port protocol, where the driving instruction is collected by the motion collector in the simulated cockpit according to the motion of the user;

sending the driving instruction to the unmanned vehicle corresponding to the simulated cockpit, so as to enable the unmanned vehicle to travel according to the driving instruction.

In the present embodiment, the simulated cockpit can be in communication connection with the remote driving apparatus via the preset serial port protocol. Accordingly, the remote driving apparatus can receive the driving instruction sent by the simulated cockpit through the preset serial port protocol. The preset serial port protocol may specifically be any one of RS-232, RS-422, and RS-485, which will not be limited in the present disclosure. Correspondingly, after receiving the driving instruction, the remote driving apparatus can forward the driving instruction to the unmanned vehicle corresponding to the cockpit, so that the unmanned vehicle can travel safely according to the driving instruction of the user.

The remote driving method provided by the present embodiment, by receiving the driving instruction sent by the simulated cockpit through the preset serial port protocol, enables the simulated cockpit to send the collected driving instruction to the remote driving apparatus, thereby providing foundation for the remote driving of the unmanned vehicle.

FIG. 3 is a schematic flowchart of a remote driving method according to Embodiment II of the present disclosure. On the basis of any one of the preceding embodiments, as shown in FIG. 3, the method further includes:

Step 201, receiving traveling data sent by the unmanned vehicle; and

Step 202, controlling a display component in the simulated cockpit to display the traveling data, so as to enable the user to drive according to the traveling data.

In the present embodiment, since the user is required to enter the simulated cockpit to remotely drive the unmanned vehicle, the user needs to know the current traveling data of the unmanned vehicle, so as to ensure the safe traveling of the unmanned vehicle. There are a plurality kinds of data collection components provided on the unmanned vehicle, including video information collection components, such as cameras, video cameras, etc. There are also obstacle information collection components provided on the unmanned vehicle, such as radars, sensors, etc. There are also various vehicle information collection components provided on the unmanned vehicle for collecting vehicle information. After obtaining the traveling data through the above data collection components, the unmanned vehicle can send the traveling data to the remote driving apparatus. Therefore, after receiving the traveling data, the remote driving apparatus can control the display component in the simulated cockpit to display the above traveling data, so that the user can drive more safely after intuitively catching the traveling data on the display component. For example, when it is displayed on the display component that there is an obstacle near the current unmanned vehicle, the user can perform an autonomous obstacle avoidance operation according to the displayed traveling data, thereby improving the traveling safety of the unmanned vehicle.

The remote driving method provided by the present embodiment receives the traveling data sent by the unmanned vehicle, and controls the display component in the simulated cockpit to display the traveling data, so as to enable the user to drive according to the traveling data, thereby improving the traveling safety of the unmanned vehicle on the basis of realization of the remote driving of the unmanned vehicle.

Further, based on any one of the above embodiments, the traveling data includes video data, and the display component includes a display screen;

correspondingly, the method includes:

receiving the traveling data sent by the unmanned vehicle;

controlling the display screen in the simulated cockpit to display the video data to enable the user to drive according to the traveling data.

In the present embodiment, the traveling data may specifically be video data collected by the video information collection component, where the video information collection component includes but is not limited to a camera and a video camera. The video collection component can capture an actual condition within a preset range around the unmanned vehicle and sends the captured video data to the remote driving apparatus. Correspondingly, a display screen is provided in the simulated cockpit, so that after receiving the video data, the remote driving apparatus can control the display screen in the simulated cockpit to display the video data. Therefore, the user can determine the actual situation within the preset range around the unmanned vehicle according to the video data displayed in the display screen, including whether there are other vehicles, pedestrians, or the like, around the vehicle, so as to perform an autonomous obstacle avoidance operation.

The remote driving method provided by the embodiment, by controlling the display screen in the simulated cockpit to display the video data, enables the user to timely understand the current traveling data of the unmanned vehicle, thereby improving the traveling safety of the unmanned vehicle on the basis of realization of the remote driving of the unmanned vehicle.

In an embodiment, based on any one of the above embodiments, the traveling data includes dashboard data; and the display component includes a dashboard;

Correspondingly, the method includes:

receiving the traveling data sent by the unmanned vehicle;

controlling the dashboard in the simulated cockpit to display the dashboard data, so as to enable the user to drive according to the traveling data.

In the present embodiment, the traveling data may specifically be vehicle information collected by the vehicle information collection component, and may specifically include dashboard data that can be displayed through the dashboard, such as a current vehicle speed and a current fuel consumption, or the like. After collecting the dashboard data, the unmanned vehicle can send the dashboard data to the remote driving apparatus. Correspondingly, the simulated cockpit is provided with a dashboard that is consistent with that of the unmanned vehicle. Therefore, after receiving the dashboard data, the remote driving apparatus can control the dashboard in the simulated cockpit to display the dashboard data, so that the user can directly understand the current traveling condition of the vehicle according to the displayed dashboard data. For example, the user can determine whether the vehicle is currently speeding according to vehicle speed information displayed in the dashboard, and then control the traveling speed, thereby further improving the traveling safety of the unmanned vehicle.

The remote driving method provided by the present embodiment, by controlling the dashboard in the simulated cockpit to display the dashboard data, enables the user to timely understand the current traveling data of the unmanned vehicle, thereby improving the traveling safety of the unmanned vehicle on the basis of realization of the remote driving of the unmanned vehicle.

It should be noted that the above two implementations may be implemented separately or in combination. When they are implemented separately, details can be reference to in the two embodiments described above, and when they are implemented in combination, by displaying the video data through the display screen, and by displaying the dashboard data through the dashboard, the user can drive the unmanned vehicle according to the video data and the dashboard data, thereby further improving the driving safety of the unmanned vehicle. Taking the practical application as an example, if the user determines, according to the video data displayed on the display screen, that there is a pedestrian 5 meters ahead, and determines, according to the dashboard data displayed on the dashboard, that the current vehicle speed is 80 km/h, a speed reduction or braking operation can be performed timely to ensure the traveling safety.

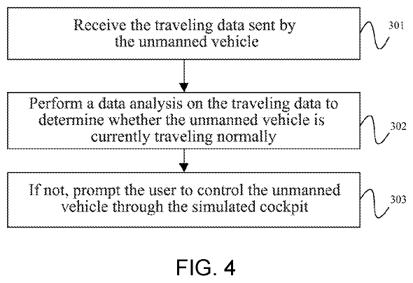

FIG. 4 is a schematic flowchart of a remote driving method according to Embodiment III of the present disclosure. On the basis of any one of the preceding embodiments, as shown in FIG. 4, the method further includes:

Step 301, receive the traveling data sent by the unmanned vehicle;

Step 302, perform a data analysis on the traveling data to determine whether the unmanned vehicle is currently traveling normally; and

Step 303, if not, prompt the user to control the unmanned vehicle through the simulated cockpit.

In the present embodiment, after receiving the traveling data sent by the unmanned vehicle, the remote driving apparatus, on one hand, may control the display component in the simulated cockpit to display the traveling data, so as to enable the user to perform driving operation according to the displayed traveling data, and on the one hand, may also perform a preliminary analysis on the traveling data to determine whether the unmanned vehicle is currently traveling normally. Specifically, whether an failure of the components in the unmanned vehicle occurs may be determined according to a time interval during which the components in the unmanned vehicle send the traveling data; whether the unmanned vehicle is currently speeding may be determined according to the current speed of the unmanned vehicle and a speed limit information corresponding to a position information; and whether a current distance between the unmanned vehicle and the obstacle is too close may be determined according to information of the current distance between the unmanned vehicle and the obstacle. It can be understood that if the user is currently in the simulated cockpit, the user may perform remote driving according to the traveling information sent by the unmanned vehicle; but if the user is currently not in the simulated cockpit, the remote driving apparatus may determine whether the unmanned vehicle is traveling safely or not according to driving information; if not, a prompt message may be sent to the user, so as to enable the user to manually adjust the traveling condition of the unmanned vehicle according to the prompt message, thereby further improving the driving safety of the unmanned vehicle.

The remote driving method provided by the present embodiment, by performing the data analysis on the traveling data to determine whether the unmanned vehicle is currently traveling normally; and if not, prompting the user to control the unmanned vehicle through the simulated cockpit, enables the user to timely understand the current traveling data of the unmanned vehicle, thereby improving the traveling safety of the unmanned vehicle on the basis of realization of the remote driving of the unmanned vehicle.

Further, based on any one of the above embodiments, the method includes:

receiving the traveling data sent by the unmanned vehicle through a WEBRTC protocol; and

controlling the display component in the simulated cockpit to display the traveling data to enable the user to drive according to the traveling data.

In the present embodiment, the remote driving apparatus may specifically in communication connection with the unmanned vehicle through the WEBRTC protocol. Accordingly, the remote driving apparatus can receive the traveling data sent by the unmanned vehicle through the WEBRTC protocol. Therefore, after receiving the traveling data, the remote driving apparatus may control the display component in the simulated cockpit to display the traveling data, so that the user can drive more safely after intuitively catching the traveling data on the display component.

The remote driving method provided by the present embodiment, by receiving the traveling data sent by the unmanned vehicle through the WEBRTC protocol, enables the user to timely understand the current traveling data of the unmanned vehicle, thereby improving the traveling safety of the unmanned vehicle on the basis of realization of the remote driving of the unmanned vehicle.

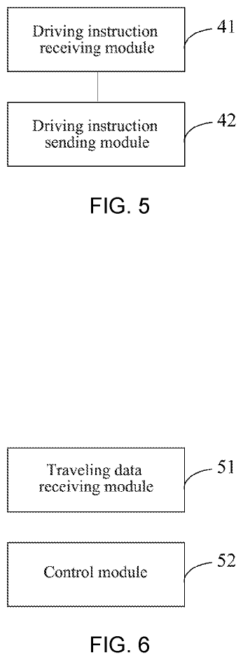

FIG. 5 is a schematic structural diagram of a remote driving apparatus according to Embodiment IV of the present disclosure. As shown in FIG. 5, the remote driving apparatus includes:

a driving instruction receiving module 41, configured to receive a driving instruction sent by a simulated cockpit, where the driving instruction is collected by a motion collector in the simulated cockpit according to a motion of a user; and

a driving instruction sending module 42, configured to send the driving instruction to an unmanned vehicle corresponding to the simulated cockpit, so as to enable the unmanned vehicle to travel according to the driving instruction.

In the present embodiment, the remote driving apparatus is in communication connection with the unmanned vehicle and the simulated cockpit, respectively, thereby enabling communication interaction with the unmanned vehicle and the simulated cockpit, respectively. In order to realize a remote driving of the unmanned vehicle, the simulated cockpit can be provided. It should be noted that the remote cockpit is provided with components such as a steering wheel and a dashboard, and the specific structure thereof is identical to that of an unmanned vehicle entity, so that the user can enter the simulated cockpit for performing simulated driving operation. In addition, a motion collector is also provided in the simulated cockpit. Specifically, when the user enters the simulated cockpit, the motion collector can collect the motion of the user in real time, form a driving instruction according to the motion information, and send the driving instruction to the remote driving apparatus, where the motion may specifically be braking, turning the steering wheel, etc. Correspondingly, after receiving the driving instruction, the remote driving apparatus can forward the driving instruction to the unmanned vehicle corresponding to the cockpit, so that the unmanned vehicle can travel safely according to the driving instruction of the user. In an embodiment, there may be multiple simulated cockpits that can correspond to the unmanned vehicles one-to-one, thereby achieving a control over the unmanned vehicles. In addition, the simulated cockpit can also correspond to multiple unmanned vehicles respectively. Before the driving of the unmanned vehicle is required to be controlled, a communication connection can be established with the unmanned vehicle according to a unique vehicle identity of the unmanned vehicle, so as to realize the control over the unmanned vehicle, which is not limited in the present disclosure.

The remote driving apparatus provided in the present embodiment receives the driving instruction sent by the simulated cockpit, where the driving instruction is collected by the motion collector in the simulated cockpit according to the motion of the user, and sends the driving instruction to the unmanned vehicle corresponding to the simulated cockpit, so as to enable the unmanned vehicle to travel according to the driving instruction. By setting up the simulated cockpit, it is possible to realize remote driving of the unmanned vehicle and to improve a driving safety of the unmanned vehicle.

Further, based on any one of the above embodiments, the driving instruction sending module includes:

a sending unit, configured to receive the driving instruction sent by the simulated cockpit through a preset serial port protocol.

FIG. 6 is a schematic structural diagram of a remote driving apparatus according to Embodiment V of the present disclosure. On the basis of any one of the preceding embodiments, as shown in FIG. 6, the apparatus further includes:

a traveling data receiving module 51, configured to receive traveling data sent by the unmanned vehicle; and

a control module 52, configured to control a display component in the simulated cockpit to display the traveling data, so as to enable the user to drive according to the traveling data.

In the present embodiment, since the user is required to enter the simulated cockpit to remotely drive the unmanned vehicle, the user needs to know the current traveling data of the unmanned vehicle, so as to ensure the safe traveling of the unmanned vehicle. There are a plurality kinds of data collection components provided on the unmanned vehicle, including video information collection components, such as cameras, video cameras, etc. There are also obstacle information collection components provided on the unmanned vehicle, such as radars, sensors, etc. There are also various vehicle information collection components provided on the unmanned vehicle for collecting the vehicle information. After obtaining the traveling data through the above data collection components, the unmanned vehicle can send the traveling data to the remote driving apparatus. Therefore, after receiving the traveling data, the remote driving apparatus can control the display component in the simulated cockpit to display the above traveling data, so that the user can drive more safely after intuitively catching the traveling data on the display component. For example, when it is displayed on the display component that there is an obstacle near the current unmanned vehicle, the user can perform an autonomous obstacle avoidance operation according to the displayed traveling data, thereby improving the traveling safety of the unmanned vehicle.

The remote driving apparatus provided by the present embodiment receives the traveling data sent by the unmanned vehicle, and controls the display component in the simulated cockpit to display the traveling data, so as to enable the user to drive according to the traveling data, thereby improving the traveling safety of the unmanned vehicle on the basis of realization of the remote driving of the unmanned vehicle.

Further, based on any one of the above embodiments, the traveling data includes the video data, and the display component includes a display screen;

correspondingly, the control module includes:

a first control unit, configured to control the display screen in the simulated cockpit to display the video data.

Further, based on any one of the above embodiments, the traveling data includes the dashboard data; and the display component includes a dashboard;

correspondingly, the control module includes:

a second control unit, configured to control the dashboard in the simulated cockpit to display the dashboard data.

Further, based on any one of the preceding embodiments, the apparatus further includes:

an analysis module, configured to perform a data analysis on the traveling data to determine whether the unmanned vehicle is currently traveling normally; and

a prompting module, configured to, if not, prompt the user to control the unmanned vehicle through the simulated cockpit.

Further, based on any one of the above embodiments, the traveling data receiving module includes:

a receiving unit, configured to receive the traveling data sent by the unmanned vehicle through a WEBRTC protocol.

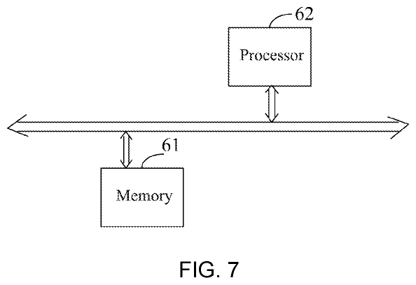

FIG. 7 is a schematic structural diagram of a remote driving device according to Embodiment VI of the present disclosure. As shown in FIG. 7, the remote driving apparatus includes: a memory 61 and a processor 62;

the memory 61 is configured to store instructions executable by the processor 62;

where the processor 62 is configured to perform the remote driving method as described in any one of the above embodiments.

A further embodiment of the present disclosure provides a computer readable storage medium, where the computer readable storage medium has stored therein a computer executed instruction that, when executed by a processor, is configured to implement the remote driving method according to any one of the embodiments described above.

Those skilled in the art can clearly understand that for the convenience and brevity of the description, the specific working process of the apparatus described above can refer to the corresponding process in the preceding method embodiments, which will not be repeated herein.

One of ordinary skill in the art will appreciate that all or part of the steps to implement the various method embodiments described above may be implemented by hardware associated with the program instruction. The preceding program can be stored in a computer readable storage medium. The program, when executed, performs the steps including the preceding various method embodiments; and the preceding storage medium includes various media that can store program codes, such as a ROM, a RAM, a magnetic disk, or an optical disk.

Finally, it should be noted that the above embodiments are merely illustrative of the technical solutions of the present disclosure, and are not to be taken in a limiting sense; although the present disclosure has been described in detail with reference to the above embodiments, those skilled in the art will understand that they may still modify the technical solutions described in the above embodiments, or equivalently substitute some or all of the technical features therein; and the modifications or substitutions do not deviate the nature of the corresponding technical solutions from the scope of the technical solutions of the embodiments of the present disclosure.

What is claimed is:

1. A remote driving method, comprising:
receiving a driving instruction sent by a simulated cockpit, wherein the driving instruction is collected by a motion collector in the simulated cockpit according to a motion of a user; and
sending the driving instruction to an unmanned vehicle corresponding to the simulated cockpit, so as to enable the unmanned vehicle to travel according to the driving instruction.

2. The method of claim 1, wherein the receiving a driving instruction sent by a simulated cockpit, comprises:
receiving the driving instruction sent by the simulated cockpit through a preset serial port protocol.

3. The method of claim 1, further comprising:
receiving traveling data sent by the unmanned vehicle;
controlling a display component in the simulated cockpit to display the traveling data, so as to enable the user to drive according to the traveling data.

4. The method of claim 3, wherein the traveling data comprises video data, and the display component comprises a display screen.

5. The method of claim 4, wherein the controlling a display component in the simulated cockpit to display the traveling data, comprises:
controlling the display screen in the simulated cockpit to display the video data.

6. The method of claim 3, wherein the traveling data comprises dashboard data; and the display component comprises a dashboard.

7. The method of claim 5, wherein the controlling a display component in the simulated cockpit to display the traveling data, comprises:
controlling the dashboard in the simulated cockpit to display the dashboard data.

8. The method of claim 3, wherein after the receiving traveling data sent by the unmanned vehicle, the method further comprises:
performing a data analysis on the traveling data to determine whether the unmanned vehicle is currently traveling normally; and
if not, prompting the user to control the unmanned vehicle through the simulated cockpit.

9. The method of claim 3, wherein the receiving traveling data sent by the unmanned vehicle, comprises:
receiving the traveling data sent by the unmanned vehicle through a WEBRTC protocol.

10. A remote driving apparatus, comprising:
a transceiver, a memory, a processor, and a computer program stored on the memory and operable on the processor,
wherein the processor, when running the computer program, is configured to:
control the transceiver to receive a driving instruction sent by a simulated cockpit, wherein the driving instruction is collected by a motion collector in the simulated cockpit according to a motion of a user; and
control the transceiver to send the driving instruction to an unmanned vehicle corresponding to the simulated cockpit, so as to enable the unmanned vehicle to travel according to the driving instruction.

11. The apparatus of claim 10, wherein the processor is further configured to:
control the transceiver to receive the driving instruction sent by the simulated cockpit through a preset serial port protocol.

12. The apparatus of claim 10, wherein the processor is further configured to:
control the transceiver to receive traveling data sent by the unmanned vehicle; and
control a display component in the simulated cockpit to display the traveling data, so as to enable the user to drive according to the traveling data.

13. The apparatus of claim 12, wherein the traveling data comprises video data, and the display component comprises a display screen.

14. The apparatus of claim 13, wherein the processor is further configured to:
control the display screen in the simulated cockpit to display the video data.

15. The apparatus of claim 12, wherein the traveling data comprises dashboard data; and
the display component comprises a dashboard.

16. The apparatus of claim 15, wherein the processor is further configured to:
control the dashboard in the simulated cockpit to display the dashboard data.

17. The apparatus of claim 12, wherein the processor is further configured to:
perform a data analysis on the traveling data to determine whether the unmanned vehicle is currently traveling normally

18. The apparatus of claim 17, wherein the processor is further configured to:
if not, prompt the user to control the unmanned vehicle through the simulated cockpit.

19. The apparatus of claim 12, wherein the processor is further configured to:
control the transceiver to receive the traveling data sent by the unmanned vehicle through a WEBRTC protocol.

20. A nonvolatile memory, wherein the nonvolatile memory has stored therein a computer executed instruction that, when executed by a processor, is configured to implement the remote driving method of claim 1.
